(19) United States
(12) Patent Application Publication
(10) Pub. No.: US 2009/0201675 A1
(43) Pub. Date: Aug. 13, 2009

(54) Linear light source device

(75) Inventors: Hiroaki Onishi, Kyoto-shi (JP); Hideki Sawada, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto (JP)

(21) Appl. No.: 12/217,969

(22) Filed: Jul. 10, 2008

(30) Foreign Application Priority Data
Jul. 13, 2007 (JP) 2007-184099

(51) Int. Cl. F21S 4/00; F21V 1/00

(52) U.S. Cl. 362/223; 362/217.05

(57) ABSTRACT

A linear light source device includes a transparent light guide member of an elongate shape having a longitudinal axis. The light guide member includes a first end, a second end and a main body sandwiched between the first end and the second end. The linear light source device further includes a light emission unit arranged to face a light incident surface of the first end. The first end includes an entering-light controlling portion having a diameter which increases as progressing from the light incident surface toward the main body. The entering-light controlling portion changes the direction of the light emitted from the light emission unit.

### BACKGROUND OF THE INVENTION

1. Field of the Invention

The present invention relates to a linear light source device. More particularly, the present invention relates to a linear light source device suitable for use as an illumination light source of an image reader designed to read a two-dimensional image printed on e.g. recording paper.

2. Description of the Related Art

It is demanded that a linear light source device for use in an image reader is capable of illuminating a linearly extending illumination target uniformly and efficiently. Conventionally, a cold cathode tube has been widely used as such a linear light source device. However, the use of a cold cathode tube has the following drawbacks. Firstly, a cold cathode tube is vulnerable to shock. Secondly, a power supply circuit for obtaining a predetermined drive voltage is expensive. Thirdly, since mercury vapor is sealed in a cold cathode tube, it may have a bad effect on the environment when a cold cathode tube breaks.

In recent years, therefore, as disclosed in JP-A-2003-346509, for example, a linear light source device has been proposed which includes a light emitting diode (LED) arranged at an end of a bar-shaped light guide member. The outer surface of the light guide member includes a light emitting portion extending linearly in the longitudinal direction. The light emitted from the LED travels in the light guide member and is then emitted from the light emitting portion. This type of linear light source device is resistant to shock and can be driven by a simple power supply.

The light guide member disclosed in JP-A-2003-346509 has a cross section which is uniform in the longitudinal direction. The light emitted from the LED impinges on an end of the light guide member while spreading radially. Thus, after entering the light guide member through the end, most part of the light reaches the circumferential surface of the light guide member at an angle smaller than the total reflection critical angle, and hence, is wastefully emitted to the outside. To prevent this, the above-described gazette proposes to cover the outer circumferential surface (excluding the light emitting portion) of the light guide member with a white reflective film. However, the provision of the white reflective film to cover the outer circumferential surface increases the number of process steps and cost for manufacturing the linear light source device.

### SUMMARY OF THE INVENTION

The present invention has been proposed under the circumstances described above. It is, therefore, an object of the present invention to provide a linear light source device in which the light introduced does not wastefully leak from the light guide member to the outside without the provision of a reflection film.

A linear light source device provided according to the present invention comprises a transparent light guide member of an elongate shape having a longitudinal axis, the light guide member including a first end, a second end and a main body sandwiched between the first end and the second end, and a first light emission unit arranged to face a light incident surface of the first end. The first end includes an entering-light controlling portion having a diameter which increases as progressing from the light incident surface toward the main body.

Preferably, the linear light source device of the present invention further comprises a second light emission unit arranged to face a light incident surface of the second end.

The second end may be provided with a light reflecting surface instead of the second light emission unit. Preferably, in this case, the second end includes a reflection controlling portion having a diameter which reduces as separating from the main body along the longitudinal axis.

Preferably, the light incident surface provided at the first end comprises a flat surface extending perpendicularly to the longitudinal axis. Alternatively, the light incident surface may comprise a curved surface connected to the entering-light controlling portion and bulging to be away from the main body in a direction along the longitudinal axis.

Preferably, the light reflecting surface provided at the second end comprises a flat surface extending perpendicularly to the longitudinal axis. Alternatively, the light reflecting surface may comprise a curved surface connected to the reflection controlling portion and bulging to be away from the main body in a direction along the longitudinal axis.

Preferably, the light guide member includes a circumferential surface in which a strip region extending in a direction along the longitudinal axis and a light emitting region facing the strip region are defined. The strip region is provided with a light scattering reflector for reflecting light, after the light has entered the light guide member, toward the light emitting region.

Preferably, the light scattering reflector includes a plurality of recesses or a plurality of projections.

In a linear light source device having the above-described structure, light is effectively prevented from leaking from the outer circumference of an end of the light guide member without the provision of a reflection film on the outer circumferential surface of the end of the light guide member. As a result, the light emitted from the light emission unit is efficiently utilized as illumination light.

Other features and advantages of the present invention will become more apparent from the detailed description given below with reference to the accompanying drawings.

### BRIEF DESCRIPTION OF THE DRAWINGS

FIG. 1 is a schematic view showing the overall structure of a linear light source device according to a first embodiment of the present invention;

FIG. 2 is a sectional view taken along lines II-II in FIG. 1;

FIG. 3 is a sectional view taken along lines III-III in FIG. 2;

FIG. 4 is a schematic view showing the overall structure of a linear light source device according to a second embodiment of the present invention;

FIG. 5 is a sectional view taken along lines V-V in FIG. 4;

FIG. 6 is a sectional view showing a variation of the first embodiment; and

FIG. 7 is a sectional view showing a variation of the second embodiment.

### DETAILED DESCRIPTION OF THE PREFERRED EMBODIMENTS

Preferred embodiments of the present invention will be described below with reference to the accompanying drawings.

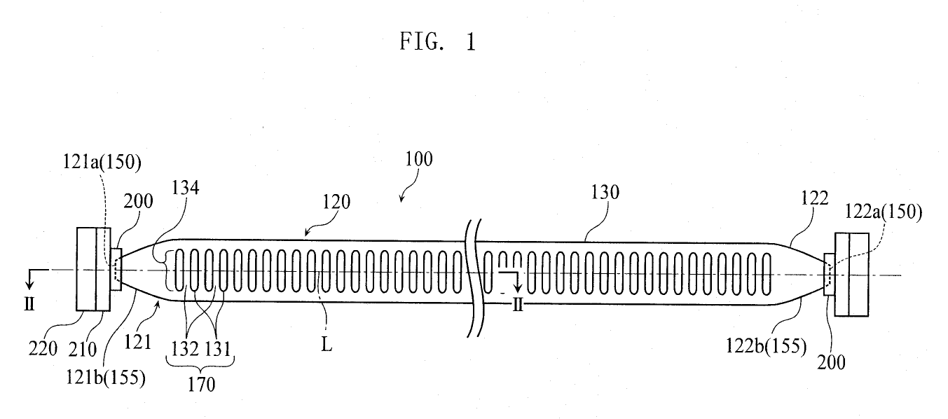

FIGS. 1-3 show a linear light source device 100 according to a first embodiment of the present invention. The linear light source device 100 includes a light guide member 120 and light emission units 200 respectively arranged at the ends of the light guide member 120.

As shown in FIG. 1, the light guide member 120 includes a columnar main body 130 and a first and a second ends 121 and 122 integrally formed at the ends of the main body 130. The main body 130 has a uniformly circular cross section throughout the length. The light guide member 120 is made of a transparent resin such as PMMA or polycarbonate and has a straight longitudinal axis L. The main body 130 has a diameter of e.g. about 4 mm. The outer surface of the light guide member 120 is a smooth mirror surface.

As will be understood from FIGS. 1-3, a strip region 134 having a constant width and extending in the longitudinal direction of the main body 130 is defined in a circumferential surface of the main body 130. The strip region 134 is positioned between the first end 121 and the second end 122. A light scattering reflector 170 is provided in the strip region 134. The light scattering reflector 170 comprises a plurality of recesses 131 and projections 132 alternately arranged in the longitudinal direction of the main body 130. Each of the recesses 131 and each of the projections 132 are elongated in the width direction of the strip region 134.

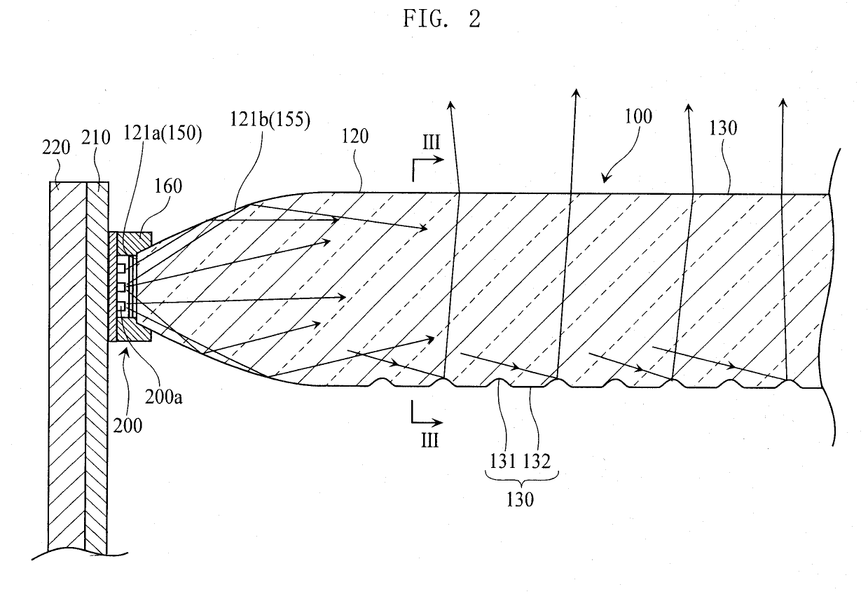

As shown in FIGS. 1 and 2, the first end 121 and the second end 122 include a first end surface 121a and a second end surface 122a, respectively, which are flat surfaces extending perpendicularly to the longitudinal axis L. The first end 121 and the second end 122 further include a first tapered portion 121b and a second tapered portion 122b, respectively. The diameter of each of the first tapered portion 121b and the second tapered portion 122b gradually increases as progressing inward (i.e., toward the main body 130) along the longitudinal axis L. Each of the tapered portions 121b and 122b functions as an entering-light controlling portion 155, which will be described later. In the illustrated example, the side surface of each of the tapered portions 121b and 122b has a convex generatrix. However, the present invention is not limited to this, and the generatrix may be straight. (In this case, the tapered portions 121b and 122b are in the form of a truncated cone.)

The first light emission unit 200 is arranged to face the first end surface 121a. The first light emission unit 200 is positioned to intersect the longitudinal axis L. Similarly, the second light emission unit 200 is arranged to face the second end surface 122a. The second light emission unit 200 is also positioned to intersect the longitudinal axis L. With this arrangement, each of the end surfaces 121a and 122a functions as a light incident surface 150 through which the light emitted from each light emission unit 200 enters the light guide member 120.

The light emission units 200 are mounted on substrates 210 in advance, and in this state, arranged to face the end surfaces 121a and 122a, respectively. Each of the light emission units 200 is a packaged device incorporating a plurality of LED chips 200a. In this embodiment, each light emission unit 200 integrally includes a reflecting member 160 provided at the front surface. The reflecting member receives the end of the tapered portion 121b, 122b of the light guide member 120. With this arrangement, the light emission unit 200 is properly connected to the light guide member 120 to face the end surface 121a, 122a. As each light emission unit 200, one that emits white light is suitably used. In this case, all the LED chips 200a may emit white light or the LED chips 200a may include a red (R) LED chip, a green (G) LED chip, and a blue (B) LED chip.

The substrate 210 may be in the form of an elongated rectangle. The light emission unit 200 is mounted at one of longitudinally opposite ends of the substrate. The other portions of the substrate are utilized as a heat dissipation region or a region for arranging a wiring pattern. The substrate 210 is made of aluminum nitride having excellent heat conductivity. In the illustrated example, to enhance the heat dissipation, a heat dissipation plate 220 made of aluminum or aluminum alloy is laminated on the reverse surface of the substrate 210. The heat dissipation plate 220 has a predetermined thickness, which is larger than that of the substrate 210 in the illustrated example.

The advantages of the linear light source device 100 having the above-described structure will be described below.

The light emitted from each of the light emission units 200 enters the light guide member 120 from each end surface 121a, 122a (light incident surface 150). As shown in FIG. 2, since light is radially emitted from the light emission unit 200, the light entering the end 121, 122 of the light guide member 120 travels while spreading in the radial direction (i.e., the direction perpendicular to the longitudinal direction) of the light guide member 120. As noted before, the ends 121 and 122 of this embodiment include tapered portions 121b and 122b (entering-light controlling portions 155) respectively. Thus, although the light travels while spreading in the radial direction, the light impinges on the inner surface of the tapered portion 121b, 122b at an angle larger than the total reflection critical angle. As a result, the light is totally reflected to be guided into the main body 130 of the light guide member 120 without wastefully leaking to the outside.

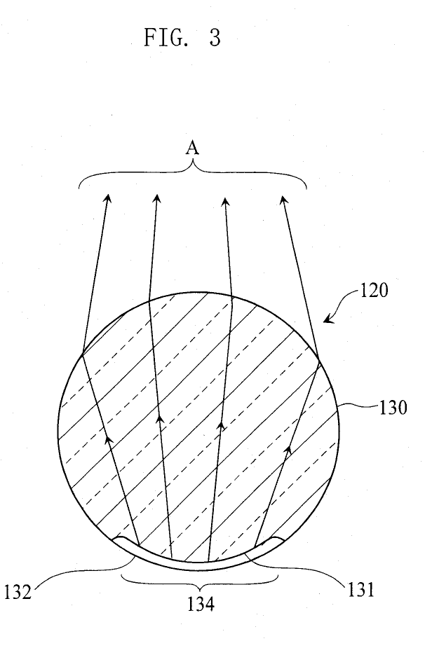

As shown in FIG. 2, the light having entered the main body 130 travels in the longitudinal direction while being totally reflected by the smooth surfaces. Part of this light is reflected by the recesses 131 and changes its direction to traverse the main body 130. Then, as shown in FIG. 3, the light travels toward a region (light emitting region) facing the strip region 134 of the main body 130. Then, the light impinging on the circumferential surface of the main body 130 at an angle smaller than the total reflection critical angle is emitted to the outside. In this process, due to the convex lens effect of the columnar main body 130, the emitted light converges on a target irradiation region A. To make the intensity of the light to be emitted from the light emitting region uniform, the depth of each recess 131 or the pitch between adjacent recesses 131 may be appropriately adjusted.

In the linear light source device 100, aluminum nitride is employed as the material of the substrate 210. Further, the substrate 210 includes a heat dissipation region in addition to the region for mounting the light emission unit 200. Moreover, the heat dissipation plate 220 is bonded to the reverse surface of the substrate 210. With this arrangement, the heat generated in turning on the light emission unit 200 is efficiently dissipated to the outside. Thus, the light emission unit 200 can be operated continuously at a high output for a long time.

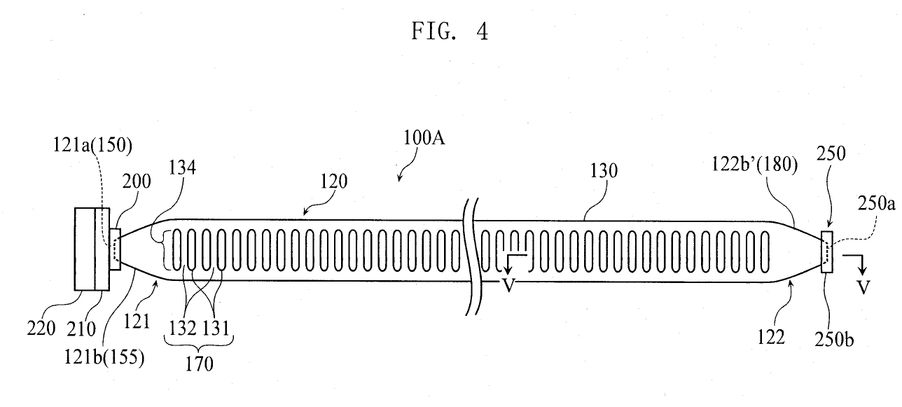

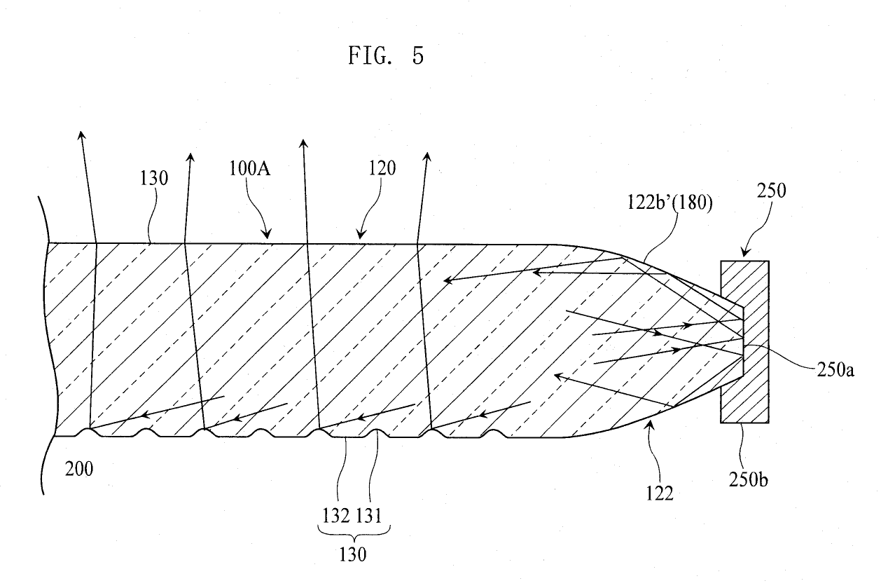

FIGS. 4 and 5 show a linear light source device 100A according to a second embodiment of the present invention. The linear light source device 100A differs from the linear light source device 100 of the first embodiment in that the second end 122 of the light guide member 120 is provided with a reflecting means 250. The structure of other portions is basically identical or similar to that of the linear light source device 100. In FIGS. 4 and 5, the elements which are identical or similar to those shown in FIG. 1-3 are designated by the same reference signs as those used for the figures, and the description thereof will be omitted.

As shown in FIG. 5, the second end 122 of the light guide member 120 includes a tapered portion 122b′ having a diameter which gradually reduces as progressing outward (i.e., away from the main body 130) along the longitudinal axis (not shown). The end of the tapered portion 122b′ comprises a flat light reflecting surface 250a extending perpendicularly to the longitudinal axis. A reflecting member 250b made of white resin is mounted to cover the light reflecting surface 250a. In the illustrated example, the tapered portion 122b′ has a convex generatrix. Alternatively, however, the tapered portion may have a straight generatrix. As the reflecting means 250, instead of mounting the reflecting member 250b to the reflecting surface 250a, a reflective film of white paint or a metal film may be formed on the light reflecting surface 250a.

Part of the light having entering the light guide member 120 from the first end 121 (see FIG. 4) is emitted to the outside from the circumferential surface of the main body 130 as illumination light, while the other part of the light reaches the second end 122 to be reflected by the reflecting means 250. Since the above-described tapered portion 122b′ is formed at the second end 122, most part of the reflected light impinges on the tapered portion 122b′ (specifically, the surface 180 of the tapered portion) at an angle larger than the total reflection critical angle. As a result, the light is totally reflected without wastefully leaking to the outside. The light then travels within the main body 130 in the reverse direction to be utilized as illumination light. In this way, the tapered portion 122b′ of the second embodiment functions as a reflection controlling portion for controlling the reflection of light.

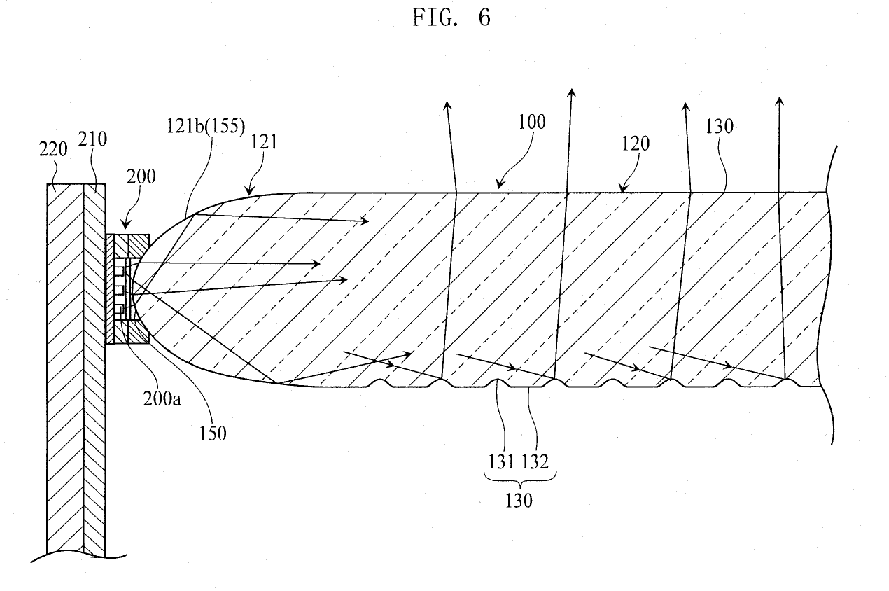

FIG. 6 is a sectional view showing a principal portion of a variation of the first embodiment. In the structure shown in the figure, the light incident surface 150 of the light guide member 120 is a smooth convex surface continuously connected to the tapered portion 121b (entering-light controlling portion 155). The structure of other portions is the same as that shown in FIGS. 1-3.

With the structure shown in FIG. 6, the convex light incident surface 150 functions like a convex lens to cause the light emitted radially from the light emission unit 200 to approach the longitudinal axis of the light guide member 120. This further reduces the possibility that the light entering the light guide member 120 impinges on the tapered portion 121b (entering-light controlling portion 155) at an angle smaller than the total reflection critical angle, so that the light is reliably prevented from wastefully leaking to the outside.

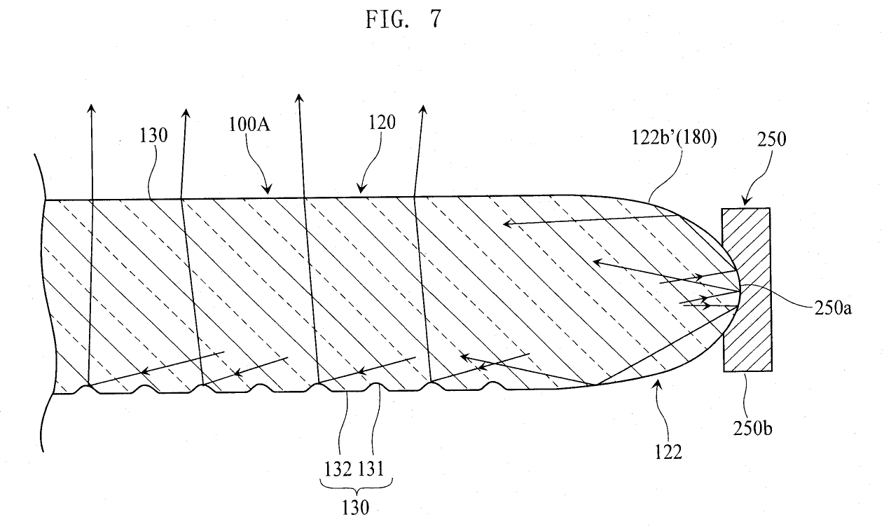

FIG. 7 is a sectional view showing a principal portion of a variation of the second embodiment. In the structure shown in the figure, the light reflecting surface 250a is a smooth convex surface continuously connected to the tapered portion 122b′ (reflection controlling portion 180) This arrangement reduces the possibility that the light reflected by the reflecting means 250 impinges on the tapered portion 122b′ (reflection controlling portion 180) at an angle smaller than the total reflection critical angle, so that the light is reliably prevented from wastefully leaking to the outside.

Although the light guide member in the foregoing examples is columnar and has a straight longitudinal axis, the present invention is not limited to this. For instance, the light guide member may have a polygonal or oval cross section. The light guide member as a whole may be curved into a U-shape.

In the foregoing examples, a strip region extending in the longitudinal direction is defined in the circumferential surface of the light guide member, and the light scattering reflector is provided by forming recesses and projections in the strip region. Unlike this, however, the light scattering reflector of the present invention may be provided by applying white or generally white paint to the strip region. The width of the paint to be applied may be adjusted to make the intensity of the light emitted from the light emitting region of the light guide member uniform.

1. A linear light source device comprising:
a transparent light guide member elongated along a longitudinal axis, the light guide member including a first end, a second end and a main body sandwiched between the first end and the second end; and
a first light emission unit facing a light incident surface of the first end;
wherein the first end includes an entering-light controlling portion having a diameter which increases as progressing from the light incident surface toward the main body.

2. The linear light source device according to claim 1, further comprising a second light emission unit facing a light incident surface of the second end.

3. The linear light source device according to claim 1, further comprising a light reflecting surface provided at the second end.

4. The linear light source device according to claim 3, wherein the second end includes a reflection controlling portion having a diameter which reduces as proceeding away from the main body along the longitudinal axis.

5. The linear light source device according to claim 1, wherein the light incident surface comprises a flat surface extending perpendicularly to the longitudinal axis.

6. The linear light source device according to claim 1, wherein the light incident surface comprises a curved surface connected to the entering-light controlling portion and bulging to be away from the main body in a direction along the longitudinal axis.

7. The linear light source device according to claim 3, wherein the light reflecting surface comprises a flat surface extending perpendicularly to the longitudinal axis.

8. The linear light source device according to claim 4, wherein the light reflecting surface comprises a curved surface connected to the reflection controlling portion and bulging to be away from the main body in a direction along the longitudinal axis.

9. The linear light source device according to claim 1, wherein the light guide member includes a circumferential surface provided with a strip region extending along the longitudinal axis and with a light emitting region facing the strip region, the strip region being provided with a light scattering reflector for reflecting light having entered the light guide member toward the light emitting region.

10. The linear light source device according to claim 9, wherein the light scattering reflector includes a plurality of recesses or projections.
